(19) United States
(12) Patent Application Publication
(10) Pub. No.: US 2019/0205981 A1
(43) Pub. Date: Jul. 4, 2019

(54) TSE: A TECHNICAL INDICATOR AND RELATED STATISTIC FUNCTIONS FOR A BETTER TRADING DECISION

(71) Applicant: Tse Lee, Houston, TX (US)

(72) Inventor: Tse Lee, Houston, TX (US)

(21) Appl. No.: 15/859,347

(22) Filed: Dec. 30, 2017

(51) Int. Cl. G06Q 40/04; G06N 7/00

(52) U.S. Cl. CPC G06Q 40/04; G06N 7/005

(57) ABSTRACT

A technical indicator, TSE (Thrust, Sideway Engagement), is introduced. There are many reasons for this new indicator. The first one is to use this TSE to predict the price movement range. The second one is to use this TSE as a trading tool. The final one is to know how reliable this TSE is before using it.

The construction of this TSE consists of one new tool and three other well-known tools. Interestingly, the combination of these four tools will work in a complimentary way. It is working in such way that it can alleviate the potential problems of each individual tool. As a result, the final TSE will track the price movement and provide some useful information.

The verification process of the TSE is to use the linear regression on the security price and its TSE value. When we have the F-statistic test score of this TSE, we can know how well the TSE is tracking the security price. The larger the F-statistic score is, the more confident we have in this TSE value.

### BACKGROUND OF THE INVENTION

Most standard number-based tools such as the Relative Strength Index (RSI) and the Stochastic (K/D) indicator display the overbought and oversold information. These tools are not designed to track prices. Thus, they cannot tell a lot about the underlying security price. In the same number-based category, the moving average (MA) related tools only focus on the crossover of another MV line to generate a signal. They also do not track or forecast prices.

On the other hand, the chart and pattern formation are often used to make a price projection. The pattern recognition is quite subjective. Sometimes, the pattern can only be confirmed after some time passes. These processes all require some human interpretations and working experiences to achieve a better result.

The question here is if there is a new way to recognize the opportunity. The additional information can make a trading decision more reliable. Most importantly, we can know beforehand that this method is still reliable or deteriorating.

### SUMMARY OF THE INVENTION

My invention hereinafter described a new technical indicator TSE (Thrust, Sideway Engagement). It consists in the combination of three industry-standard components and a newly created indicator component. Each component is specially chosen, and the ending combination result is designed to track the underlying security price.

An object of the present invention is to provide the forecast capability on the price movement of underlying securities. Most indicators use the overbought or oversold line for the probability of price reversion. In our invention, we introduce the probability distribution from the TSE in addition to the overbought and oversold concept.

Yet another object of the present invention is to provide a system using security selections for a better trading result. Thus, we know beforehand that the TSE may not work well with certain securities, or the price movement ranges will be very low and not worthy for the trading purpose on certain securities.

Still another object of the present is to provide a more reliable system for a trading decision. It is done by the unique feature of a Thrust mode and a Sideway mode from the TSE indicator interactions.

### DESCRIPTION OF THE SEVERAL VIEWS OF THE DRAWING

FIG. 1 relates to the indicator components and the corresponding parameters.

FIG. 2 relates to the regression analysis on the indicator and each component. It also displays the average F-statistic score of each component.

FIG. 3 relates to the regression analysis on the indicator and each component on partial data. The complementary effect of each component can be shown on some securities.

FIG. 4 relates to the indicator movement for a trading decision on the weekly data.

FIG. 5 relates to the forecast capability on a specific security.

### DESCRIPTION OF THE INVENTION

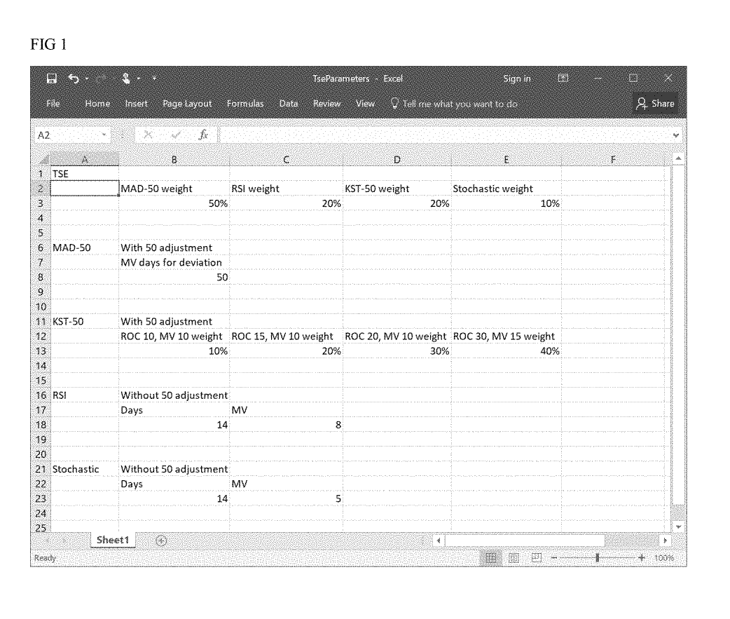

FIG. 1 shows the weighted components of one TSE (Thrust, Sideway Engagement) indicator. The current parameter setting of each component is used for a system-wide scanning purpose although each security can have its own individual setting to improve the result. The whole decision system is based on this TSE indicator. The Relative Strength Index (RSI) and the Stochastics (K/D) are well-known indicators. Although not so popular, the KST (Known Sure Thing) is used by certain people. The KST-50 is the existing KST indicator with the additional adjustment value of 50. Most importantly, a newly created component is the MAD-50 (Moving Average Deviation with the 50-Value Adjustment). The MAD-50 is calculated by the deviation percentage away from its moving average (i.e. 50-day or 50-week MA in the system-wide setting) and then adjusted by the value 50. The MAD-50 formula looks as follows:

$$\frac{( Price - {MV}_{50} ) \times 100}{{MV}_{50}} + 50$$

The MAD-50 has the most weight inside the TSE indicator. Once we have the TSE value at any given time, we can use this indicator to predict the price. It is done by running the linear regression on the TSE value and the price value. If the model is reasonably sound, the expected price and the actual price should be very close. The formula looks as follows:

(Expected Price)ₜ=ε+β*(TSE)ₜ

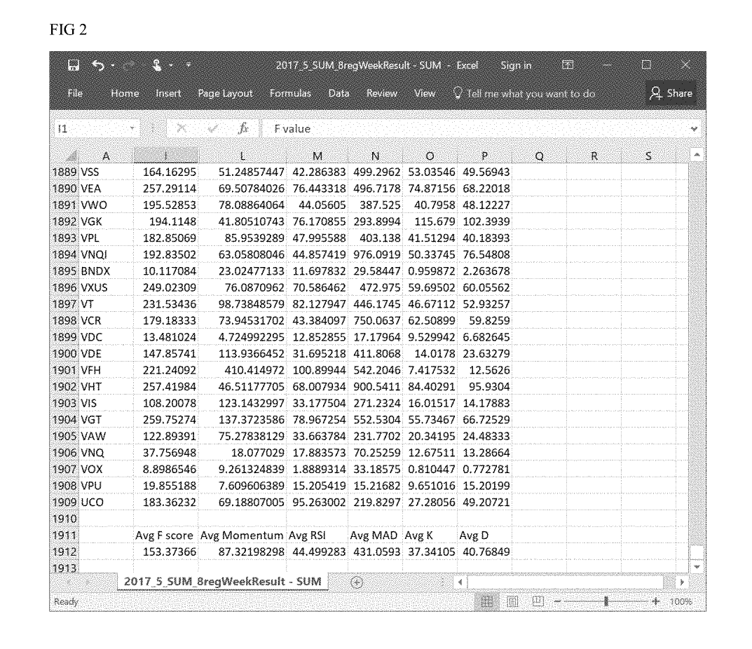

FIG. 2 shows the linear regression F-statistic score on the 1908 securities. The average F-statistic score of TSE and MAD-50 are 153.37 and 431.0593 respectively. This indicates that the MAD-50 follows the price very well. Thus, it contains most weights on the construction of TSE indicator. In general, other components such as RSI, Momentum (KST- 50), and K/D (Stochastic) do not have high F-statistic score as expected.

As we all know, the higher the F-statistic score is, the better the linear regression model will be. Normally, we will select any security as our candidate to track or engage when its TSE's F-statistic score is above 100. The logic behind the construction of TSE works as follows.

Most trend-following indicators tend to lag for some periods due to the moving average feature to smooth out whipsaws. We use the KST-50 as our proxy for the trend-following component. As we also know that the Stochastic loses the further pushing power when it reaches high or low values prematurely. Although not as obvious as the Stochastic, the RSI suffers the same problem. It is especially true when the security price keeps moving in one direction for a long time. A moving average on RSI can alleviate the problem, but it can introduce the delay response due to the moving average feature. Thus, a new indicator TSE is formed for this reason. The following paragraphs describe the force interactions on each stage of an uptrend.

During the early stage of an uptrend, the Stochastic and the MAD-50 move up. The RSI may delay a few days depending on the smoothing setting. The KST-50 is also lagging behind at this time. As a result, the TSE gets the driving force from the MAD-50 and the Stochastic. This stage is normally at the beginning of a thrust mode.

During the middle stage of an uptrend, the MAD-50, the KST-50, and the RSI can still push the value while the Stochastic is stuck at high values and cannot contribute further. Thus, the TSE gets the extra driving force from the MAD-50, the RSI, and the KST-50. This stage is probably still in a thrust mode.

During the late stage of an uptrend, the MAD-50 is dropping since the security price and its 50-day MA are converging. At this time, the KST-50 and the RSI keep pushing up even the price incremental is very small or even flat. In this case, the TSE gets the main driving force from the KST-50 and the RSI. The other three indicators can correct the early dropping of MAD-50 value in this stage. Most likely, this stage is in a sideway mode.

The same logic on each stage is also true for the downtrend. These four indicator-components work in a complimentary mode to form the TSE indicator. As the result, all the side effects are alleviated or corrected by other indicators in all different stages.

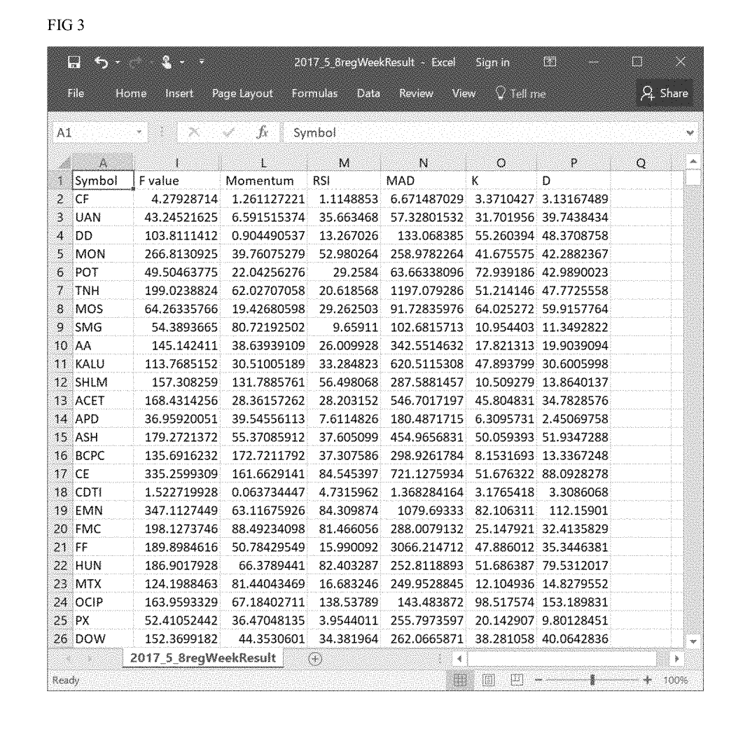

There is a tradeoff in this TSE construction. In some cases, we are willing to sacrifice a little bit F-statistic score to gain the timing of trigger signals by adding other tools. As a result, we can get the TSE closer to the RSI or the KST-50 to enter a thrust mode or a sideway mode. The thrust or sideway concept will be introduced in the following paragraphs. Interestingly, the security MON on row 5 in FIG. 3 is a perfect example of complimentary work of each component. The TSE's F-statistic score 266.81 is higher than each of the TSE components. The same case also happened on the security OCIP on row 24.

We use the TSE as a trading tool. The way we construct the TSE is to treat the TSE like a price, the RSI like a shorter moving average, and the KST-50 like a longer moving average. Although the TSE contains the RSI and the KST-50 components, the TSE compares with the individual RSI and the KST-50 on the chart.

When the TSE moves away from the RSI and the KST-50 on the chart either to the upside or downside, it is considered a thrust mode. On the other hand, when the TSE enters the range bounded by the RSI and the KST-50, it is considered as a sideway mode. In general, we can take a position (buy or short) when a security is in a thrust mode. When the security is changing to a sideway mode, we close that position. Of course, the oversold or overbought can provide the additional condition for confirmations.

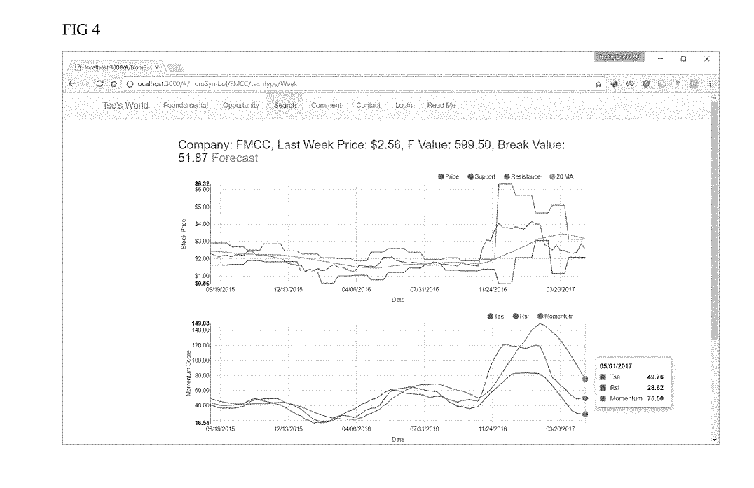

FIG. 4 displays security FMCC on a weekly chart. It had a strong uptrend thrust movement started in the middle of November 2016 when the TSE crossed the Momentum line (KST-50). This thrust mode ended when the TSE crossed again on the Momentum line (KST-50) in the middle of December 2016. On the top of this screen, the F-statistic score has 599.50 value. This value indicates the TSE is trustworthy based on the linear regression result on the historical data.

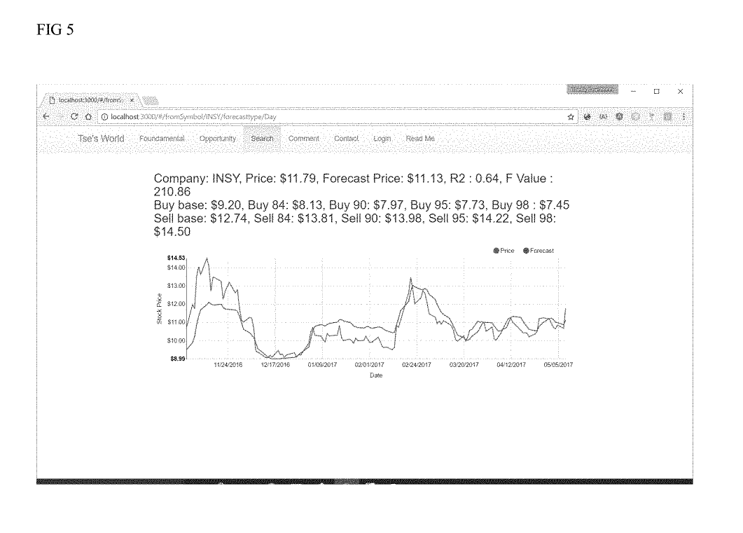

FIG. 5 shows a chart as well as a group of forecast numbers. The chart shows the actual price and the forecast price based on the historical TSE value. The buy-base price is calculated by the TSE at 30, and the sell-base price is calculated by the TSE at 70. In general, TSE at 30 will be oversold, while TSE at 70 will be overbought. The difference between the buy-base and the sell-base is considered the volatility range. This INSY security has a 38-percent range. We can use the calculated volatility number to filter out securities with small volatility. The “buy 84” means the expected price on TSE value 30 as the mean value and adding the deviation values to get the 84-percent zone. This probability concept is based on the normal distribution curve. In our interpretation, the price will have 84-percent probability to recover when the security drops to that low. When the actual price is moving to our preset boundaries (buy-base or sell-base), these forecast numbers can be treated as a probability of reversal reference. Most securities should move in a range bounded by the buy-base and the sell-base. Extra profit opportunities occur when the price moves out of the range and then swing back to other directions.

1. The object one of the new invention is to provide the forecast capability on the price movement of underlying securities. This feature can let us know the probability of price reversion based on the statistics analysis.
The object two of the new invention is to provide a system using security selections for a better trading result. This feature will increase the chance of trading success by filtering out unsuitable securities.
The object three of the new invention is to provide a more reliable system for a trading decision. This feature will provide a more reliable result than just relying on the overbought and oversold condition along. Especially, the conventional oversold concept is hard to avoid the catching-the-falling-knife trap. The Thrust and Sideway concept can provide the additional information on the driving force.
